(19) United States
(12) Patent Application Publication
(10) Pub. No.: US 2011/0022767 A1
(43) Pub. Date: Jan. 27, 2011

(54) DMA CONTROLLER WITH INTERRUPT CONTROL PROCESSOR

(75) Inventors: Ik Jae CHUN, Daejeon (KR); Chun Gi Lyuh, Daejeon (KR); Jung Hee Suk, Daejeon (KR); Tae Moon Roh, Daejeon (KR); Jong Kee Kwon, Daejeon (KR); Jong Dae Kim, Daejeon (KR)

Correspondence Address: AMPACC Law Group, PLLC, 6100 219th Street SW, Suite 580, Mountlake Terrace, WA, 98043, US

(73) Assignee: Electronics and Telecommunications Research Institute, Daejeon (KR)

(21) Appl. No.: 12/843,801

(22) Filed: Jul. 26, 2010

(30) Foreign Application Priority Data
Jul. 27, 2009 (KR) 10-2009-0068430
Jun. 3, 2010 (KR) 10-2010-0052154

(51) Int. Cl. G06F 13/28; G06F 13/24

(52) U.S. Cl. 710/308; 710/260

(57) ABSTRACT

Provided is a direct memory access (DMA) controller having an interrupt control processor that can process DMA transmission-related interrupts according to a control program modifiable by a user. The DMA controller includes the interrupt control processor that can process a DMA transmission-related interrupt and a DMA request interrupt transmitted from peripheral devices and control the DMA channel through the control program that can be modified by the user, so that DMA channel control and relevant interrupt processing loads caused by a plurality of DMA data transmissions are reduced, and the flexibility of DMA channel control and interrupt processing in control of the DMA controller is provided to the user.

### CROSS-REFERENCE TO RELATED APPLICATION

This application claims priority to and the benefit of Korean Patent Application Nos. 10-2009-0068430, filed Jul. 27, 2009 and 10-2010-0052154, filed Jun. 3, 2010, the disclosures of which are incorporated herein by reference in their entirety.

### BACKGROUND

1. Field of the Invention

The present invention relates to a direct memory access (DMA) controller having an interrupt control processor, and more particularly, to a DMA controller that can control DMA transmission between peripheral devices or between a peripheral device and memory without a main processor's control by having an interrupt control processor that can process DMA transmission-related interrupts according to a control program modifiable by a user.

2. Discussion of Related Art

In the case of data transmission by a plurality of peripheral devices and data transmission through a memory, system performance can be improved by performing DMA transmission. However, for such DMA transmission, it is necessary to set a DMA controller to control DMA channels for predetermined DMA transmission operations, and peripheral devices use an interrupt signal to request such DMA transmission. Particularly, a peripheral device functioning as an external interface requires frequent interrupt processing due to frequent data transmission.

Conventionally, interrupt processing and DMA channel setting is performed by a main processor to control the DMA controller's operation or DMA transmission is controlled by an interrupt processing module of the DMA controller itself. However, interrupt processing by the main processor causes system performance degradation due to frequent interrupt processing requests and DMA channel setting.

The interrupt processing by the DMA controller can reduce an interrupt processing load of the main processor in some extent, but it is not suitable for interrupt processing requested from a plurality of peripheral devices according to various situations, because interrupt processing and DMA channel transmission are performed according to a fixed priority set by the DMA controller.

In case of a system on chip (SoC) structure, in which a number of processors and various types of peripheral devices are integrated within one system, load for controlling an operation of the DMA controller further increases. In addition, many operation requests for a DMA channel may increase interrupts.

For these reasons, a DMA controller for processing various DMA-related interrupts generated from peripheral devices and controlling DMA channels in an effective manner is needed.

### SUMMARY OF THE INVENTION

The present invention is directed to providing a DMA controller with an embedded interrupt control processor to improve DMA controller performance and the whole system performance.

The present invention is also directed to providing a DMA controller in which, in data transmission between a peripheral device and a memory or between peripheral devices, DMA transmission-related interrupts are flexibly and rapidly controlled by an interrupt control processor that is organically associated with other DMA transmission modules in the DMA controller, so that an interrupt processing load of the system is reduced, and a DMA transmission setting that satisfies a user's demand is possible, thereby improving DMA controller performance and system control performance.

An aspect of the present invention provides a DMA controller, including: a DMA channel register bank for storing a DMA channel operation request received from an external processor and DMA configuration values for DMA transmission control; a program memory for storing a control program for processing an interrupt related to DMA transmission; an interrupt control processor for executing the control program stored in the program memory in response to a DMA request interrupt generated from a peripheral device or the DMA channel operation request received from the external processor; a DMA channel control module for controlling an operation of a DMA channel according to the DMA configuration values stored in the DMA channel register bank and enables DMA transmission to be performed, in response to a DMA channel activation command of the interrupt control processor; and an interrupt/DMA request/release module for receiving the DMA request interrupt generated from the peripheral device, forwarding the DMA request interrupt to the interrupt control processor, and generating a release signal for an interrupt completely processed by the interrupt control processor.

### BRIEF DESCRIPTION OF THE DRAWINGS

The above and other features and advantages of the present invention will become more apparent to those of ordinary skill in the art by describing in detail preferred embodiments thereof with reference to the attached drawings in which:

FIG. 1 illustrates an external interface structure of a DMA controller according to an exemplary embodiment of the present invention;

FIG. 2 illustrates an internal structure of a DMA controller according to an exemplary embodiment of the present invention; and

FIGS. 3A and 3B are control flowcharts illustrating a DMA channel transmission control scheme through a general main processor and a DMA channel transmission control scheme through an interrupt control processor according to an exemplary embodiment of the present invention.

### DETAILED DESCRIPTION OF EXEMPLARY EMBODIMENTS

Hereinafter, exemplary embodiments of the present invention will be described in detail. However, the present invention is not limited to the embodiments disclosed below, but can be implemented in various forms. Therefore, the following embodiments are described in order for this disclosure to be complete and enabling to those of ordinary skill in the art.

Throughout the below description, when a certain part “includes” another part, this does not exclude any other part but means that any other part can be further included unless otherwise set forth herein. The terms “unit” and “module” used herein refer to a unit processing at least one function or operation and can be realized as hardware or software or a combination of hardware and software.

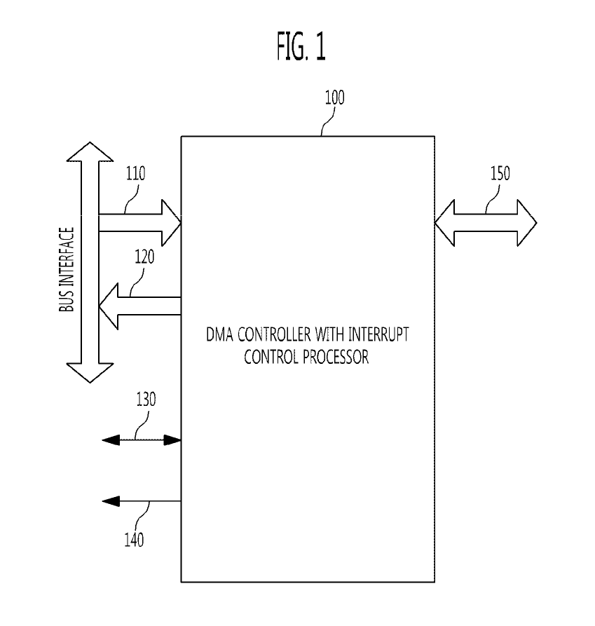

FIG. 1 illustrates an external interface structure of a DMA controller according to an exemplary embodiment of the present invention. As illustrated in FIG. 1, a DMA controller 100 is connected with a DMA control bus 110, an interrupt control master bus 120, an interrupt request/release interface 130, an interrupt transmission interface 140, and a DMA channel 150.

The DMA control bus 110 provides an interface with an external bus. A processor, such as a main processor, outside the DMA controller 100 may set an operation of the DMA channel 150 for performing DMA data transmission through the DMA control bus 110 and check its state. Also, a program to be executed by an interrupt control processor in the DMA controller 100 is loaded into a program memory in the DMA controller 100 and configuration values necessary for controlling a DMA channel operation can be transmitted through the DMA control bus 110 to control an operation of the interrupt control processor.

The interrupt control master bus 120 provides an interface through which the interrupt control processor can access internal registers of peripheral devices.

The DMA control bus 110 and the control master bus 120 may be connected to the same bus as illustrated in FIG. 1 or connected to separate buses.

The interrupt request/release interface 130 receives a DMA transmission request interrupt from peripheral devices or other devices or transmits an interrupt release signal.

The interrupt transmission interface 140 transmits a DMA controller interrupt to an interrupt processor such as a main processor or an interrupt controller in the system.

The DMA channel 150 may be composed of a one-port or two-port DMA channel. The DMA channel 150 may include multiple channels that are physically separated.

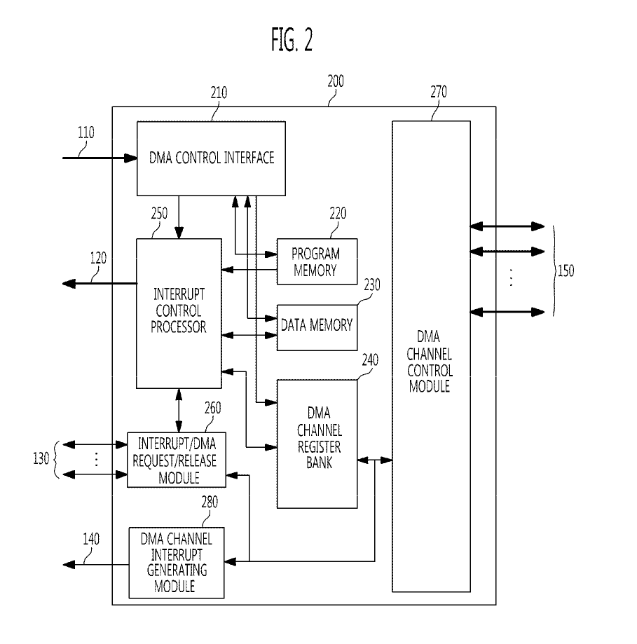

FIG. 2 illustrates an internal structure of a DMA controller according to an exemplary embodiment of the present invention. As illustrated in FIG. 2, a DMA controller 200 may include a DMA control interface 210, a program memory 220, a data memory 230, a DMA channel register bank 240, an interrupt control processor 250, an interrupt/DMA request/release module 260, a DMA channel control module 270, and a DMA channel interrupt generating module 280.

The DMA control interface 210 provides an interface between an external processor including the main processor and the DMA controller. The DMA control interface 210 may receive a program to be executed by the interrupt control processor 250 and relevant data from the external processor and store the program and the relevant data in the program memory 220 and the data memory 230, respectively. The external processor may set a DMA channel operation request or DMA configuration values used for controlling a DMA channel and DMA controller operation, through the DMA control interface 210, in the DMA channel register bank 240. The external processor may also access a specific memory region of the data memory 230, in which data needed to control the interrupt control processor 250 is stored, or a relevant register within the DMA channel register bank 240. The DMA configuration values may include source and destination addresses for DMA data transmission, a transmission data size, and a DMA channel control value.

The program memory 220 stores a control program for controlling DMA transmission. The control program is executed by the interrupt control processor 250.

The data memory 230 stores data related to execution of the interrupt control processor 250. Both of the program memory 220 and the data memory 230 may be accessed by the external processor through the DMA control interface 210.

The DMA channel register bank 240 may include registers storing the DMA configuration values used for controlling the DMA channel and the DMA controller operation, such as the source and destination addresses for DMA data transmission, the transmission data size, and the DMA channel control value, a register for storing the DMA channel operation request received from the main processor, a register for storing a state of the DMA channel control module 270, and an activation command register for storing a DMA channel activation command for activating the DMA channel operation. The DMA channel register bank 240 may be accessed by the external processor through the DMA control interface 210 and by the interrupt control processor 250.

The interrupt control processor 250 activates the DMA channel operation by performing an operation designated by the control program previously stored in the program memory 220, in response to the DMA request interrupt of the peripheral device received through the interrupt/DMA request/release module 260 and the DMA channel operation request received from the external processor and stored in the DMA channel register bank 240.

The interrupt control processor 250 that recognized the DMA request interrupt from the peripheral device through the interrupt/DMA request/release module 260 checks an internal register of the corresponding peripheral device thought the interrupt control master bus 120 in order to check the state of the peripheral device that requested DMA transmission. Thereafter, the interrupt control processor 250 starts the channel operation of the DMA channel control module 270 by storing the DMA configuration values such as the source and destination addresses for DMA channel operation and the transmission data size in the DMA channel register bank 240 and setting the channel activation command in the DMA channel activation register of the DMA channel register bank 240. The DMA configuration values may be set in the control program.

Alternatively, the interrupt control processor 250 that recognized the DMA request interrupt of the peripheral device may start the channel operation of the DMA channel control module 270 by storing the DMA configuration values determined by the control program in the DMA channel register bank 240 without checking the state of the peripheral device and setting the channel activation command in the DMA channel activation register of the DMA channel register bank 240.

As another example, the interrupt control processor 250 may activate the channel operation of the DMA channel control module 270 by recognizing the DMA channel operation request received from the external processor and stored in the DMA channel register bank 240, storing the DMA configuration values in the DMA channel register bank 240, and setting the channel activation command in the DMA channel activation register of the DMA channel register bank 240.

When a DMA transmission completion interrupt indicating that data transmission of a fixed size was completed through the DMA channel is received from the interrupt/DMA request/release module 260, the interrupt control processor 250 generates the interrupt release signal through the interrupt/DMA request/release module 260 and then performs DMA setting for next DMA transmission.

These operations are specified in the control program, which was previously stored in the program memory 220 for the interrupt control processor 250. The DMA configuration values to be stored in the DMA channel register bank 240 may be specified by the control program. According to an exemplary embodiment of the present invention, various interrupt processing routines may be performed by changing the control program according to the user's request. A DMA control routine and DMA interrupt processing related to DMA transmission, which were processed by the main processor in the conventional art, are performed by the interrupt control processor 250 using the control program, thereby reducing a load of the main processor. Further, since the interrupt control processor 250 can control DMA transmission considering the characteristic of the system, it is possible to effectively control the DMA controller.

The interrupt control processor 250 may be implemented using a general purpose processor or a processor dedicated for interrupt processing and may control the interrupt/DMA request/release module 260.

The DMA channel control module 270 controls the DMA channel operation according to the DMA configuration values stored in the DMA channel register bank 240 and thus enables DMA transmission to be performed, in response to the DMA channel activation command of the interrupt control processor 250. Generally, one DMA transmission allows data of a fixed size to be transmitted. Accordingly, in order to transmit all data of a size set in the DMA channel register bank 240, a plurality of DMA transmission operations are required. The state of the DMA channel control module 270 is stored in the DMA channel register bank 240. State information indicating completion of the DMA transmission may be stored in the DMA channel register bank 240 each time transmission of data having a fixed size is completed through the DMA channel under control of the DMA channel control module 270.

The interrupt/DMA request/release module 260 transmits the DMA request interrupt, which is received from various peripheral devices through the interrupt request/release interface 130, to the interrupt control processor 250, generates the release signal for an interrupt completely processed by the interrupt control processor 250, and transmits the release signal to the peripheral devices or the DMA channel interrupt generating module 280. The interrupt/DMA request/release module 260 checks the state of the DMA channel control module 270 stored in the DMA channel register bank 240, generates the DMA transmission completion interrupt each time transmission of data having a fixed data size is completed by the DMA channel control module 270, and transmits the DMA transmission completion interrupt to the interrupt control processor 250. The interrupt/DMA request/release module 260 transmits the interrupt release signal to the DMA channel interrupt generating module 280 when an interrupt related to DMA transmission of the last data is finally processed by the interrupt control processor 250. Further, a function of changing the order and selection of the peripheral device that requested interrupt processing may be provided through control of the interrupt control processor 250.

The DMA channel interrupt generating module 280 generates the DMA channel operation completion interrupt indicating that data transmission of a predetermined transmission data size was finally competed through the DMA channel and an interrupt related to the internal state of the DMA controller and transmits the interrupts to an external interrupt controller. The DMA channel interrupt generating module 280 may generate the DMA channel operation completion interrupt and transmit the DMA channel operation completion interrupt to the external interrupt controller when the interrupt release signal is received from the interrupt/DMA request/release module 260.

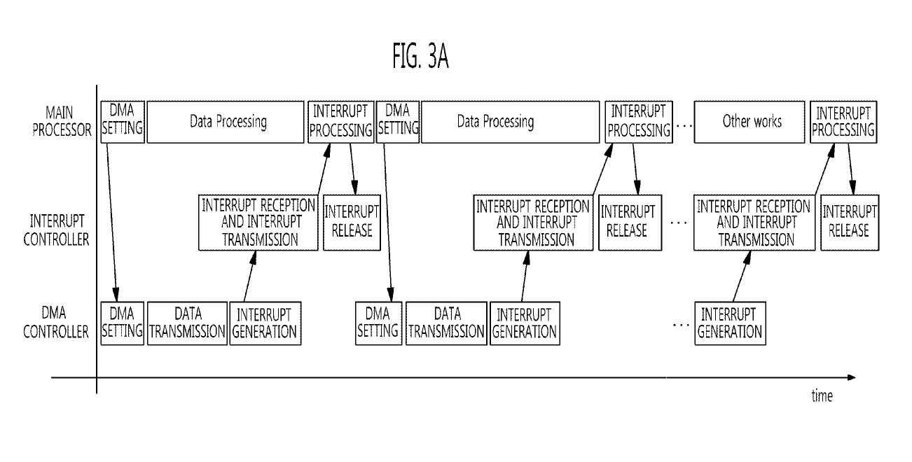

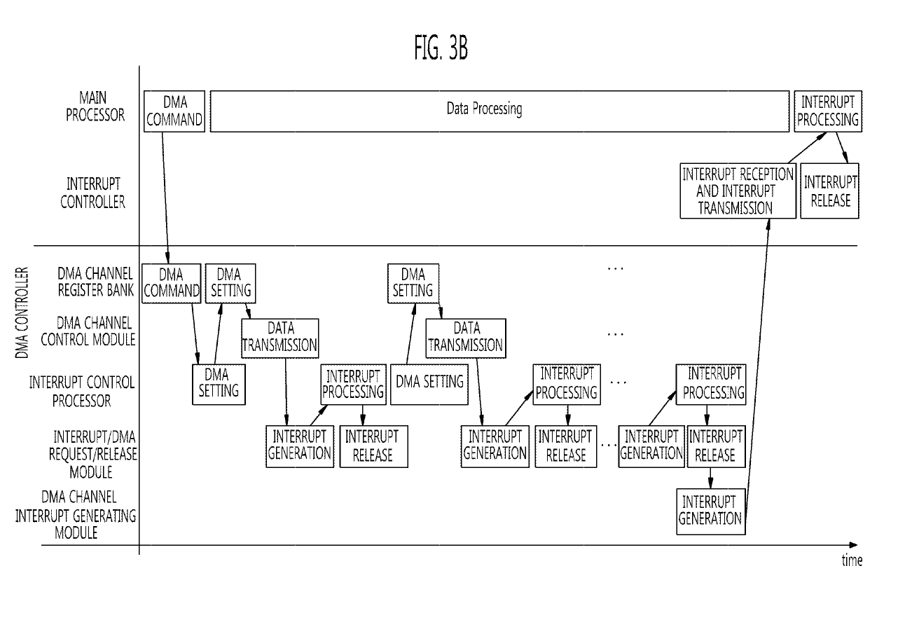

FIGS. 3A and 3B are control flowcharts illustrating a DMA channel transmission control scheme through a typical main processor and a DMA channel transmission control scheme through an interrupt control processor according to an exemplary embodiment of the present invention, respectively. As illustrated in FIG. 3A, in the case of controlling DMA channel transmission through the main processor, many interrupts are periodically generated when a large amount of data is transmitted, and processing of these interrupts causes a performance reduction of the main processor.

FIG. 3B illustrates a DMA channel transmission control flow according to an exemplary embodiment of the present invention. Specifically, FIG. 3B illustrates the flow of processing an interrupt related to DMA transmission through an interrupt control processor according to an exemplary embodiment of the present invention when the DMA channel operation is requested by the main processor.

As illustrated in FIG. 3B, when the main processor sets the DMA channel operation request command in the DMA channel register bank 240, the interrupt control processor 250 executes the control program stored in the program memory to perform an operation related to DMA transmission. Specifically, the interrupt control processor 250 stores the DMA configuration values designated by the control program in the DMA channel register bank 240 and activates the DMA channel control module 270. The DMA channel control module 270 performs DMA transmission of a fixed data size. The interrupt/DMA request/release module 260 that recognized that DMA transmission was completed by the DMA channel control module 270 generates the DMA transmission completion interrupt and transmits the DMA transmission completion interrupt to the interrupt control processor 250, and the interrupt control processor 250 that received the DMA transmission completion interrupt prepares a next DMA operation. When the DMA operation for the last data is completed by repeating this operation, the interrupt control processor 250 notifies the interrupt/DMA request/release module 260 that DMA transmission was finally completed. The interrupt/DMA request/release module 260 transmits the interrupt release signal to the DMA channel interrupt generating module 280. The DMA channel interrupt generating module 280 that received the interrupt release signal generates the DMA channel operation completion interrupt and transmits the DMA channel operation completion interrupt to the external interrupt controller.

According to the present invention, the interrupt control processor 250, which can process DMA transmission-related interrupts and the DMA request interrupt from the peripheral devices and control the DMA channel through the control program that can be modified by the user, can be included within the DMA controller. Therefore, DMA channel control and relevant interrupt processing loads caused by a plurality of DMA data transmissions, which may occur when the main processor controls DMA transmission, are reduced, and the flexibility of DMA channel control and interrupt processing in control of the DMA controller is provided to the user. Therefore, the DMA transmission request from the external device can be processed to be specific to devices requesting DMA.

While the invention has been shown and described with reference to certain exemplary embodiments thereof, it will be understood by those skilled in the art that various changes in form and details may be made therein without departing from the spirit and scope of the invention as defined by the appended claims.

What is claimed is:

1. A direct memory access (DMA) controller, comprising:
a DMA channel register bank for storing a DMA channel operation request received from an external processor and DMA configuration values for DMA transmission control;
a program memory for storing a control program for processing an interrupt related to DMA transmission;
an interrupt control processor for executing the control program stored in the program memory in response to a DMA request interrupt generated from a peripheral device or the DMA channel operation request received from the external processor;
a DMA channel control module for controlling an operation of a DMA channel according to the DMA configuration values stored in the DMA channel register bank and enables DMA transmission to be performed, in response to a DMA channel activation command of the interrupt control processor; and
an interrupt/DMA request/release module for receiving the DMA request interrupt generated from the peripheral device, forwarding the DMA request interrupt to the interrupt control processor, and generating a release signal for an interrupt completely processed by the interrupt control processor.

2. The DMA controller according to claim 1, wherein the DMA configuration values include data source address, destination address and a transmission data size for DMA data transmission and a DMA channel control value.

3. The DMA controller according to claim 1, wherein the interrupt control processor stores the DMA configuration values designated by the control program into the DMA channel register bank and then stores the DMA channel activation command into the DMA channel register bank.

4. The DMA controller according to claim 3, wherein the DMA channel control module starts DMA transmission using the DMA channel when the DMA channel activation command is stored into the DMA channel register bank.

5. The DMA controller according to claim 1, wherein the interrupt control processor checks an internal state of a peripheral device that generated the DMA request interrupt through an interrupt control master bus connected to the DMA controller.

6. The DMA controller according to claim 1, wherein the interrupt/DMA request/release module generates a DMA transmission completion interrupt and transmits the DMA transmission completion interrupt to the interrupt control processor each time data transmission of a fixed size is completed through the DMA channel.

7. The DMA controller according to claim 1, further comprising a data memory for storing data necessary to execution of the interrupt control processor.

8. The DMA controller according to claim 1, further comprising a DMA control interface for providing an interface with the external processor, wherein the DMA channel operation request and the control program are received through the DMA control interface.

9. The DMA controller according to claim 1, further comprising, a DMA channel interrupt generating module for generating a DMA channel operation completion interrupt indicating that data transmission of a transmission data size included in the DMA configuration values was finally completed through the DMA channel and an interrupt related to an internal state of the DMA controller and transmits the interrupts to an external interrupt controller.

10. The DMA controller according to claim 1, wherein the DMA controller communicates with the peripheral device and the external processor through at least one of a DMA control bus, an interrupt control master bus, an interrupt request/release interface, and an interrupt transmission interface.
